(19) United States
(12) Patent Application Publication
(10) Pub. No.: US 2012/0233764 A1
(43) Pub. Date: Sep. 20, 2012

(54) Sauna Device

(76) Inventor: Seung Woo Lee, Yorba Linda, CA (US)

(21) Appl. No.: 13/230,586

(22) Filed: Sep. 12, 2011

(30) Foreign Application Priority Data
Sep. 13, 2010 (KR) 10-2010-0089648

(51) Int. Cl. A61H 33/06

(52) U.S. Cl. 4/524

(57) ABSTRACT

A sauna device comprises a sauna room installed with a first heating element and a heating room installed below the sauna room, and includes an air-intake hole and an air-vent hole for introducing air from outside to the sauna room and a second heating element, such that since a heating body is provided in a lower portion of the floor of the sauna room and it is heated by a radiative heat, the floor of the sauna room is kept in a constant temperature, so as to provide a convenient usage and the sauna room can be kept refreshing through air circulation.

### BACKGROUND OF THE INVENTION

The present invention relates to a sauna device, and more specifically to a sauna device for whole body, in which a user enter a sauna room and enjoy.

In general, the sauna provides various effects such as facilitating blood circulation and skin respiration and easing out of fatigue and muscle relaxation by applying steam and heat into the sauna, device and having the user sweat.

For such a sauna, usually the users used a facility for sauna in a public bath house, but recently a small-sized sauna devices were introduced, such that it was able to be used conveniently at home.

Home sauna device can be divided to a wet-type sauna device and a dry-type sauna device according to the medium such as steam or heat, and to a whole-body sauna device and half-body sauna device according to the range of body of the user to which the steam or heat is applied.

An example of the half-body sauna device was disclosed in Korean Application Publication 20-2008-000571, which discloses a frame having a wall body with open top and bottom and a planar heating body, a film heater attached therein, such that the user sits in and the heat is applied up to the chest portion.

An example of the whole-body sauna device was disclosed in a Korean Patent Number 20-0255910, which includes a sauna room frame if a box shape enclosed by a floor and wall body and a planar heating body that is attached to the inner surface and radiating far infrared, such that the user enters the enclosed sauna room.

And, for seeing through and ventilation between the inside and outside of the sauna room, the sauna device can have a transparent glass sliding window on a top central portion above the entrance door.

However, in such a dry-type sauna device the heating body should be installed on a side portion so as to radiate toward the user's body, thus there is a problem that the temperature is low on the floor of the sauna device, giving a cold feeling to the user.

On the other hand, the half-body sauna device does not incur problems of respiration and ventilation since it takes care of portions below the heart in the body.

However, the whole-body sauna device has a problem of low oxygen density due to a limit to ventilation, since the inside of the sauna device is isolated from external air and kept at a constant temperature.

Such a sauna room may cause breathing problem, lowering of heart function, dizziness, etc. on users, which may interfere long hours of sauna.

And, since the external air is introduced directly into the sauna room when opening the entrance or window of the sauna room for ventilation, the joy of sauna may be compromised.

Therefore, in order to prevent dizziness or fainting by rarefaction of oxygen inside the sauna room and enable long hours of enjoying sauna, a Korean Patent Application Publication 2001-0079399 disclosed a whole-body sauna device providing a hose that is led out to the outside of the sauna room and an inhaling mask so as to be able to inhale the external air by perforce.

There were disclosed a valve for blocking the internal heat that might be emitted through the hose, a open/closing switch, a support, etc.

However, such a whole-body sauna device needs additional equipments such as hose or valve, is hard to use, and therefore the joy of sauna may be ruined.

Accordingly, a need for a sauna device has been present for a long time considering the expansive demands in the everyday life. This invention is directed to solve these problems and satisfy the long-felt need.

### SUMMARY OF THE INVENTION

The present invention contrives to solve the above disadvantages of the prior art and to provide a whole-body sauna device, which removes an inconvenience by a cold floor and provides a natural ventilation that keeps the temperature inside the sauna room more stably and has the users enjoy sauna for a long hours.

An object of the invention is to provide a sauna device.

The sauna device comprises: a sauna room installed with a first heating element; and a heating room installed below the sauna room, comprising an air-intake hole and an air-vent hole for introducing air from outside to the sauna room and a second heating element.

The sauna device may further comprise an open/close plate installed slidably corresponding to the air-vent hole for controlling amount of air.

The second heating element may comprise a planar heating body. The sauna device may further comprise an opening connecting the heating and the sauna room such that the planar heating body is inserted or extracted from the sauna room, and a cover installed detachably on the opening.

The heating room may comprise a guiding groove portion disposed in the heating room such that the planar heating body is slidably inserted and fixed. Also the sauna device may further comprise an opening connecting the heating and the sauna room such that the planar heating body is inserted or extracted from the sauna room, and a cover installed detachably on the opening.

The whole-body sauna device according to the invention is able to keep the temperature of floor of the sauna room providing joy of sauna, because of heating body provided below the floor of the sauna room.

Also, the whole-body sauna device according to the invention is able to control the heated external air emitted from an air vent hole through an open/closing plate installed on the floor slidably, and the heating external air is introduced into the sauna room, such that it is possible to ventilate the sauna room without lowering the temperature of the sauna room and to enjoy sauna in a refreshing condition.

Also, the whole-body sauna device according to the invention, since a second heating body may be replaced and repaired easily through an opening and a cover installed detachably on the opening when the second heating body is deteriorated or broken, may increase the easiness of work.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIGS. 1 and 2 are an assembled perspective view and a side cross-sectional view of an whole-body sauna device according to the invention;

FIG. 3 is a front view showing an whole-body sauna device according to the invention with a front plated disassembled;

FIGS. 4 and 5 are an assembled perspective view and an exploded perspective view of an whole-body sauna device according to the invention; and

FIG. 6 is a side cross-sectional view showing usage of an whole-body sauna device according to the invention.

### DETAILED DESCRIPTION EMBODIMENTS OF THE INVENTION

This application claims priority to Korean Patent App. Ser. No. 10-2010-0089648 filed Sep. 13, 2010, all of which are hereby incorporated by reference.

Below, an whole-body sauna device according to the invention is described in detail referring to the figures.

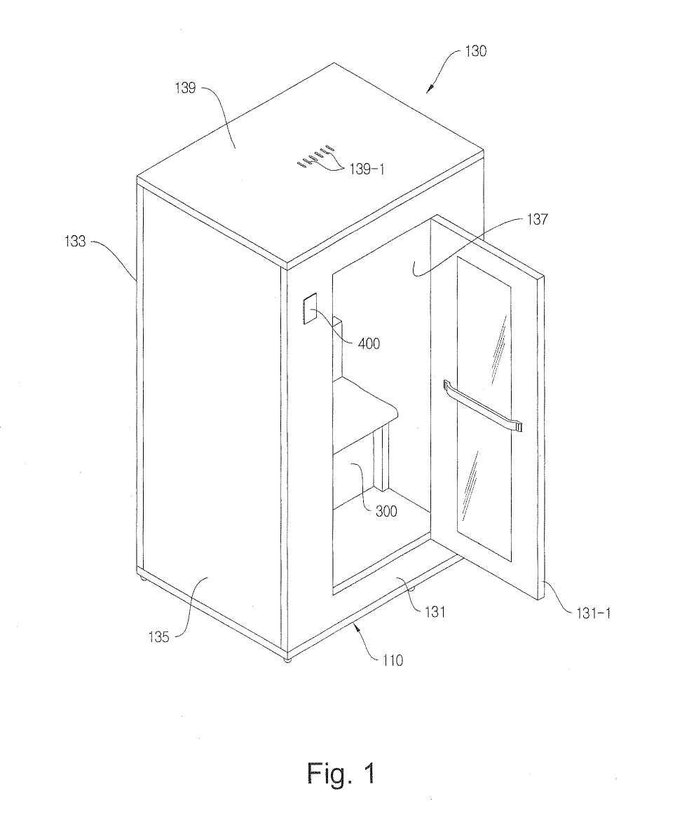

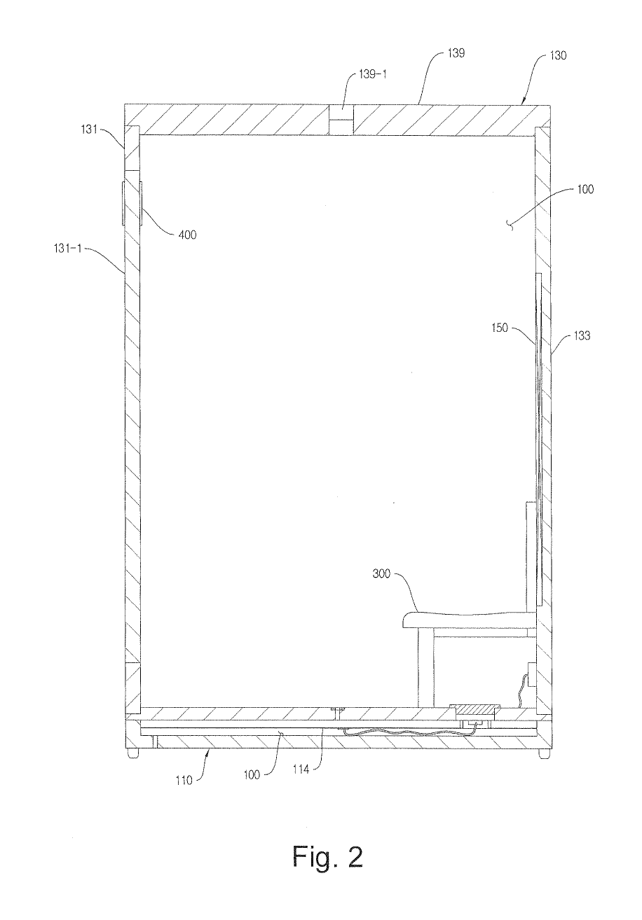

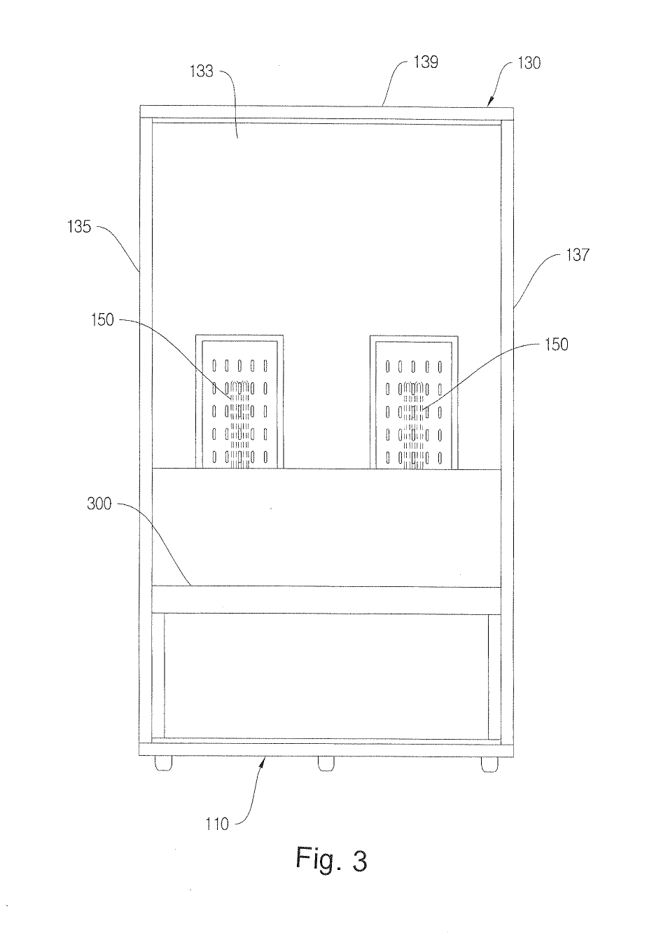

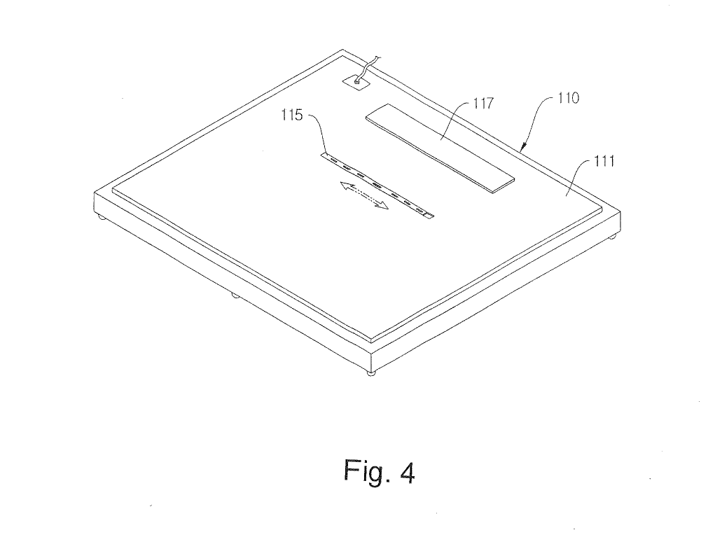

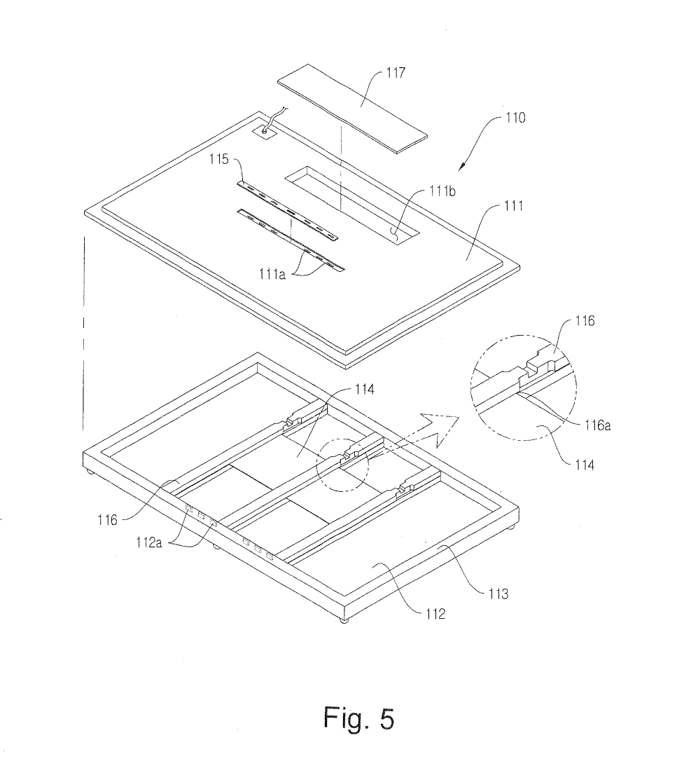

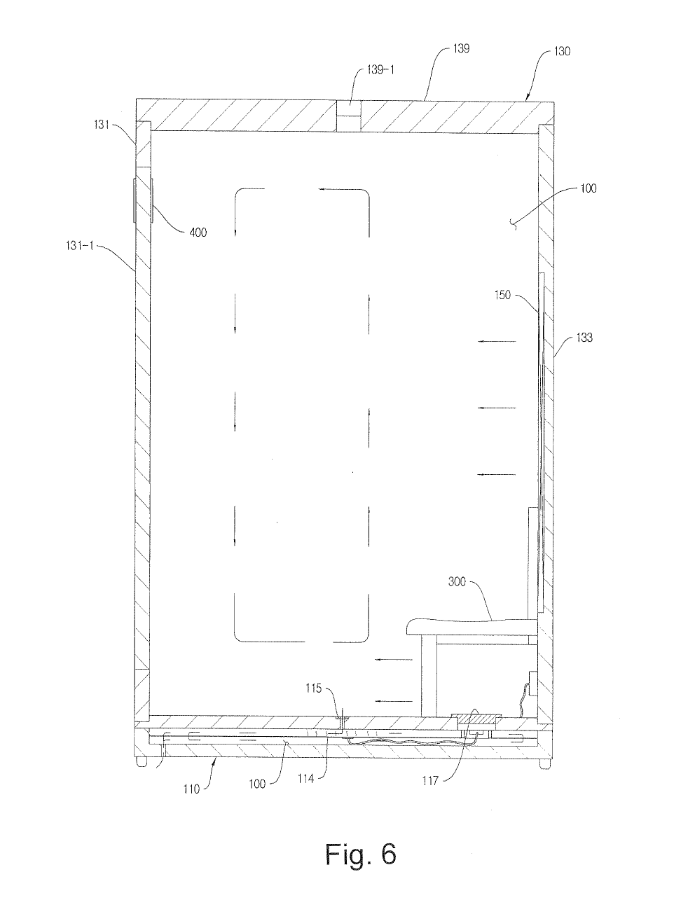

FIGS. 1 and 2 are an assembled perspective view and a side cross-sectional view of an whole-body sauna device according to the invention, FIG. 3 is a front view showing an whole-body sauna device according to the invention with a front plated disassembled, FIGS. 4 and 5 are an assembled perspective view and an exploded perspective view of an whole-body sauna device according to the invention, and FIG. 6 is a side cross-sectional view showing usage of an whole-body sauna device according to the invention.

Describing the whole-body sauna device according to the invention, the whole-body sauna device comprises a sauna room (100) and heating room (200).

The sauna room (100) comprises a floor body (110) for the user's standing and walking on, a wall body (130), and a first heating body (150).

The heating room (200) is formed inside the floor body (110), which will be described in detail below.

The wall body (130) is for enclosing the top portion of the floor body (110) and providing a closed or sealed space forming a box body along with the floor body (110), includes a front plate (131), a rear plate (133), a left side plate (135), a right side plate (137), and a ceiling plate (139), and a entrance door (131-1) is attached to the front plate (131) such that the user can enter the inside.

And, on the front plate (131) is installed a controller (400) for controlling the operation of the heating body from inside and outside.

In the embodiment, the floor body (110) and the wall body (130) was described as the sauna room (100) of a box having a shape of six-sided body, but it is just an embodiment, and the box-type sauna room (100) may be changed variously; for example it may be formed as a box-type body having a hemi-spherical wall body on the top portion of the floor body (110).

On the other hand, the floor body (110), the front plate (131), the rear plate (133), the left side plate (135), the right side plate (137), and the ceiling plate (139) may be assembled to one another by fastening means; for example, a fastening bracket having a fastening latch with a ring formed on one end and a fastening protrusion may be installed at and fasten the floor body (110), the front and rear plate (131, 133) and the right and left side plate (135, 137), and the ceiling plate (139) respectively, providing a structure fastening one another firmly.

In the ceiling plate (139) forming the wall body (130) is formed a ventilation hole (139-1) that is connected to the sauna room (100) and ventilates dry air in the inside to the outside, and to the ventilation hole (139-1) is preferably installed an open/closing plate for open/closing according to the user's control.

Also, in the ceiling plate (139) are installed an illuminating device and an audio device, such that the user enjoys the sauna along with music in a brighter mood.

The first heating body (150) includes a far-infrared material in the inside, and may be a pole-type heater that receives electrical power, generates heat, and emits far-infrared and thermal radiation.

In the case of embodiment, the first heating body (150) is installed so as to be exposed to the rear plate (133), and protected by a blocking cover formed with a plurality of holes.

The floor body (110) is disposed between the top plate (111) and the bottom plate (112) and between the top plate (111) and the bottom plate (112), and includes a rectangular frame (113) forming a space within.

And, on the bottom plate (112) and the top plate (111) are formed an air intake hole (112a) and an air vent hole (111a) respectively for introducing external air to the sauna room (100), and between the bottom plate (112) and the top plate (111) is installed a second heating body (114) for heating the external air introduced through the air intake hole (112a).

This embodiment shows forming the air intake hole (112a) in the bottom plate (112), but it is just an embodiment, and if necessary the air intake hole (112a) can be formed in the rectangular frame (113), which is not limiting.

In the air vent hole (111a) and the air intake hole (112a) are preferably installed filters such as filtering screen for preventing external objects from entering.

The second heating body (114) is a planar heating body, and may be a sheet-type heating body, in which electrodes are attached on both ends and layers of polymer insulating material are deposited.

Especially, in addition to heating the external air, the second heating body (114) transfers the heat source toward the bottom surface of the top plate (111), and since the top plate (111) is heated naturally through thermal conduction the cold feeling to the feet can be removed when entering the sauna room (100) initially.

And, the location for installing the second heating body (114) may be preferably disposed where the sole is positioned when sitting a chair (300).

Also, a open/closing plate (115) installed slidingly with respect to the air vent hole (111a) formed in the top plate (111) is installed for controlling the amount of air entering and leaving.

According to the embodiment, if the internal air is decided to be murky while the user enjoy the sauna in the sauna room (100), the external air can be introduced into the sauna room (100) by controlling the open/closing plate (115), such that the inside is circulated through the natural process of convection and the murky internal air gets mixed with the external air and refreshed.

Therefore, the user of the sauna room (100) can enjoy the sauna in a fresher environment.

Furthermore, when also opening the vent hole (139-1) of the ceiling plate (139) forming the wall body (130), the murky air can be discharged to outside more quickly.

And, in the floor body (110) is provided a guiding groove portion (116a) such that the second heating body (114) is inserted slidingly and fixed.

In this embodiment, a heating body fixing member (116) in which the guiding groove portion (116a) is formed along a length direction is installed side by side with the top surface of the bottom plate (112), and to the guiding groove portion (116a) of the heating body fixing member (116) installed side by side is inserted and fixed the second heating body (114).

And, on the top plate (111) forming the floor body (110) is formed an opening (116b) connecting the heating room (200) and the sauna room (100) such that the second heating body (114) can be inserted and extracted through the sauna room (100), and the in the opening (116b) is installed detachably a cover (117).

According to this embodiment, for replacing the second heating body (114) due to deterioration or break-down, the second heating body (114) fixed in the heating body fixing member (116) is extracted while detaching the cover (117) blocking the opening (116b), and a new second heating body (114) is inserted and replaced with.

Therefore, the maintaining work is facilitated drastically since the second heating body (114) can be replaced and repaired through the opening (116b) and the cover (117) installed detachably in the opening (116b) when the second heating body (114) gets deteriorated or broken down.

And, in the second heating body (114) may be preferably installed a bi-metal for supplying or cutting off electrical power to the second heating body (114) through thermal deformation beyond a predetermined temperature.

The operation of the present invention as described in the above is explained below.

First of all, if operating the controller (400) installed in the front plate (131), electrical power is supplied to the first heating body (150) and the second heating body (114) from outside so as to generate heat, and the first heating body (150) heats up the air in the sauna room (100) and the second heating body (114) heats the external air introduced through the air intake hole (112a) and the bottom surface of the top plate (111) forming the floor body (110).

Especially, since the floor body (110) is kept in a warm temperature by the thermal conduction of the second heating body (114), the user feels the floor not to be cold and enters warmly.

And, after a predetermined time period, the user can enjoy the sauna with the entrance door (131-1) opened, and when the internal air in the sauna room (100) is determined to be murky the user can open the open/closing plate (115) provided on the floor body (110) and introduces heated external air into the sauna room (100) through the air vent hole (111a), and refresh the air.

Furthermore, if the murky air is determined to be not refreshed, the user can open the vent hole (139-1) formed in the ceiling plate (139) and discharge the murky air swiftly to the outside and introduce heated external air persistently through the air vent hole (111a), refreshing the air in the sauna room (100) more conveniently through circulation.

On the other hand, in cases of replacing the second heating body (114) while enjoying the sauna due to deterioration or break-down, the second heating body (114) fixed to the heating body fixing member (116) is extracted in a state of the cover (117) blocking the opening (116b) detached and then a new second heating body (114) can be inserted and replaced with.

Therefore, the maintaining work is facilitated drastically since the second heating body (114) can be replaced and repaired through the opening (116b) and the cover (117) installed detachably in the opening (116b) when the second heating body (114) gets deteriorated or broken down.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A sauna device comprising:
a sauna room installed with a first heating element; and
a heating room installed below the sauna room, comprising an air-intake hole and an air-vent hole for introducing air from outside to the sauna room and a second heating element.

2. The sauna device of claim 1, further comprising an open/close plate installed slidably corresponding to the air-vent hole for controlling amount of air.

3. The sauna device of claim 1, wherein the second heating element comprises a planar heating body.

4. The sauna device of claim 3, further comprising an opening connecting the heating and the sauna room such that the planar heating body is inserted or extracted from the sauna room, and a cover installed detachably on the opening.

5. The sauna device of claim 3, wherein the heating room comprises a guiding groove portion disposed in the heating room such that the planar heating body is slidably inserted and fixed.

6. The sauna device of claim 5, further comprising an opening connecting the heating and the sauna room such that the planar heating body is inserted or extracted from the sauna room, and a cover installed detachably on the opening.

7. A sauna device comprising:
a sauna room installed with a first heating element;
a heating room installed below the sauna room, comprising an air-intake hole and an air-vent hole for introducing air from outside to the sauna room and a second heating element, wherein the second heating element comprises a planar heating body, and wherein the heating room comprises a guiding groove portion disposed in the heating room such that the planar heating body is slidably inserted and fixed;
an open/close plate installed slidably corresponding to the air-vent hole for controlling amount of air;
an opening connecting the heating and the sauna room such that the planar heating body is inserted or extracted from the sauna room, and a cover installed detachably on the opening; and
an opening connecting the heating and the sauna room such that the planar heating body is inserted or extracted from the sauna room, and a cover installed detachably on the opening.
